(19) United States
(12) Patent Application Publication
(10) Pub. No.: US 2009/0094080 A1
(43) Pub. Date: Apr. 9, 2009

(54) METHOD AND A SYSTEM FOR IMPROVING THE OPERABILITY OF A PRODUCTION PLANT

(75) Inventor: Mika LUOTOJARVI, Espoo (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 12/248,273

(22) Filed: Oct. 9, 2008

(30) Foreign Application Priority Data
Oct. 9, 2007 (EP) 07118108

(51) Int. Cl. G06Q 10/00

(52) U.S. Cl. 705/7

(57) ABSTRACT

A method for improving the operability of a production plant is invented. The production plant has at least one production process comprising at least one equipment, a system for obtaining equipment condition measuring data and a system for obtaining maintenance work data. The equipment condition measuring data and the maintenance work data is continuously acquired and stored to equipment reliability calculation system, and equipment reliability is calculated based on the equipment condition measuring data and the maintenance work data.

### SCOPE OF THE INVENTION

The present invention relates to a method and a system for improving the operability of a production plant according to the preambles of claims 1, 7 and 8.

### PRIOR ART

The trend of integrating the maintenance and repair, automation, and production functions to form an operations function in industrial plants has created a growing need for decision-making and operation assisting tools.

Overall Equipment Effectiveness (OEE) is generally used key performance indicator (KPI) in industrial production processes to tell what is the effectiveness of the equipment and what it has been in the history. OEE is calculated by multiplying three independently measured values: Availability, Performance, and Quality. OEE is a measure comparing how well manufacturing equipment is running compared to the set targets.

When Overall Equipment Effectiveness is used as a tool for controlling the operations of a plant there is no predictability component. OEE tells the history of the effectiveness and does not provide information of the future.

The predictability is based on breaking down the effectiveness of the plant to its components, possibility to drill down to the Overall Equipment Effectiveness of each sub-process and on the understanding of the relations between the processes and their sub-processes. The amount of data in a plant's existing systems' databases, i.e. automation systems, information systems, Manufacturing Execution Systems (MES), Computerized Maintenance Management Systems (CMMS), and other systems at industrial plants, is huge but unclear. The information usability of the current systems is poor, i.e. the users can not utilize it.

US 2003/0014699 A1 describes a method and system for determining the effectiveness of production installations, significant fault events that bring about deviations from a desired effectiveness and the causes of fault events.

### DESCRIPTION OF INVENTION

The purpose of the present invention is to create a method and a system for improving the operability of a production plant. In order to achieve this, the invention is characterised by the features specified in the characteristics sections of claims 1, 7 and 8. Some other preferred embodiments of the invention have the characteristics specified in the dependent claims.

In a method for improving the operability of a production plant the production plant has at least one production process comprising at least one equipment, a system for obtaining equipment condition measuring data and a system for obtaining maintenance work data. The equipment condition measuring data and the maintenance work data is continuously acquired and stored to equipment reliability calculation system. Equipment reliability is calculated based on the equipment condition measuring data and the maintenance work data.

In a system for improving the operability of a production plant, the production plant has at least one production process comprising at least one equipment, a system for obtaining equipment condition measuring data and a system for obtaining maintenance work data. The system has means for continuously acquiring the equipment condition measuring data and the maintenance work data, and means for storing the acquired equipment condition measuring data and the maintenance work data to equipment reliability calculation system, and means for calculating equipment reliability based on the equipment condition measuring and the maintenance work data.

A software product data recording medium in which program code is stored, which program code will cause a computer to perform a method for improving the operability of a production plant. The production plant has at least one production process comprising at least one equipment, a system for obtaining equipment condition measuring data and a system for obtaining maintenance work data. The equipment condition measuring data and the maintenance work data are continuously acquired and stored to equipment reliability calculation system, and equipment reliability is calculated based on the equipment condition measuring data and the maintenance work data.

In an embodiment of the method Proactive Overall Equipment Effectiveness is calculated as a product of the equipment reliability and Overall Equipment Effectiveness (OEE).

Proactive Overall Equipment Effectiveness provides information on the possibility of expected decrease of Overall Equipment Effectiveness in near future. By combining the equipment reliability to the Overall Equipment Effectiveness in real-time, it can be seen whether Overall Equipment Effectiveness is expected to stay at the current level or what is the risk for it to drop in near future.

The proactive information on the behavior of Overall Equipment Effectiveness is obtained by combining of the equipment reliability, i.e. the risk for the equipment failure or performance decrease, to Overall Equipment Effectiveness. The equipment reliability information is collected from the existing mill automation systems, information systems, user entered diary or other notes, manufacturing execution systems (MES), computerized maintenance management systems (CMMS) or other systems. The equipment reliability information can be produced also in the system calculating the Proactive Overall Equipment Effectiveness. The equipment reliability is calculated based on the equipment real-time measured data, user entered diary or other notes, laboratory measurements, maintenance, and/or other equipment information from control systems (DCS), condition monitoring systems, manufacturing execution systems (MES), and/or computerized maintenance management systems (CMMS). The equipment reliability can be produced in Computerized Maintenance Management Systems (CMMS) or other systems based on some known reliability technologies. Further, it can be calculated by comparing the current state of the preventive maintenance works to scheduled plan of maintenance works or by comparing equipment condition measurements or other measurements to their targets and set exception limits.

In the calculation of the equipment reliability a real-time integration of data in various information systems existing in the production plant is performed. For instance, the data is transferred to the maintenance managements systems from the process information and the automation systems and from the production planning and the quality managements systems. The required data may also be shared with maintenance managements systems, depending on the technical solution. This integration improves the usability of the information in production plant's existing systems. The existing information collected from different information systems is converted to support the operability of the production plant.

Proactive Overall Equipment Effectiveness can calculated in real-time by acquiring and combining the source information from the Distributed control systems (DCS), condition monitoring, Manufacturing Execution System (MES), Computerized Maintenance Management System (CMMS) and/or other existing information systems in the industrial plant.

In an embodiment of the method and a system for improving the operability of a production plant a logical model of a mill or production line is defined. It is made by dividing a mill or production line into processes and further to sub-processes and defining their connections and impacts to each others. A subprocess can contain one or more equipments or other sub-processes. The Proactive Overall Equipment Effectiveness is calculated for equipment, a subprocess, process or for a plant. If a subprocess contains several equipments, the values of the Proactive Overall Equipment Effectiveness are normalized, prioritized, and cumulated to the subprocess and further to connected sub-processes. The cumulation ends up to the Proactive Overall Equipment Effectiveness of the whole plant or production line. Each calculation of the Proactive Overall Equipment Effectiveness contains definitions for filtering the exception information in cumulation.

The system interface allows the configuration of the logical models by the users, e.g. personnel of the operations function. This makes the continuous improving of the logical models and storing the knowledge of the personnel possible.

In another embodiment of the invention the Proactive Overall Equipment Effectiveness is presented in easy to understand way to the users, i.e. plant operators and maintenance and automation personnel, i.e. operations personnel. A real-time display reveals the deviations in the Proactive Overall Equipment Effectiveness immediately. The users of the a method and a system for improving the operability of a production plant can drill down to the logical process model via the user interface and see the source components of Proactive Overall Equipment Effectiveness to find out the most significant reason for decreased value of it. Based on this information the users can make decisions for instance on what is the most important maintenance work to do, i.e. maintenance work priorization.

Proactive Overall Equipment Effectiveness is a percentage number as well as Overall Equipment Effectiveness, but in addition it contains exception information that tells whether one or more of the reliability components have violated the set exception limits, e.g. the operating hours of the equipment since last maintenance have exceed the set limit. The exception information may contain several priority levels.

The method and the system for improving the operability of a production plant help industrial plants to improve their effectiveness. The method and the system aid operations and maintenance organizations in industrial plants in their decision making.

When the method and the system for improving the operability of a production plant is used and a Proactive Overall Equipment Effectiveness is defined its value is continuously monitored. The improvement of the Proactive Overall Equipment Effectiveness can have a major impact on profitability of the production plant by increasing productivity and reducing maintenance costs, not to mention avoiding unnecessary shutdowns, major stoppages and defects.

The method and the system for improving the operability of a production plant are applicable to various industrial processes and plants, e.g. metal manufacturing, mineral manufacturing, cement manufacturing, oil and gas manufacturing, chemical manufacturing, paper and pulp manufacturing.

In an advantageous embodiment the invented method and system are performed using a computer. The programs to be used are stored in the memory of the computer or on computer readable media, which can be loaded on a computing device, for example a DVD. These computer readable media have instructions for enabling the computer to execute a method.

### FIGURES

In the following the invention will be described in more detail with the help of certain embodiments by referring to the enclosed drawings, where

FIG. 1 is a general illustration of a method for calculating the Overall Equipment Effectiveness (OEE);

FIG. 2 is a general illustration of a method for calculating the Proactive Overall Equipment Effectiveness (POEE);

FIG. 3 is a general illustration of a logical model of a mill for calculating and cumulating the Proactive Overall Equipment Effectiveness for an industrial plant;

FIG. 4 is a general illustration of a simplified logical model of a pulp and paper mill for calculating and cumulating the Proactive Overall Equipment Effectiveness;

FIG. 5 illustrates an example of calculation of the Proactive Overall Equipment Effectiveness for a sub-process in a plant.

### DETAILED DESCRIPTION

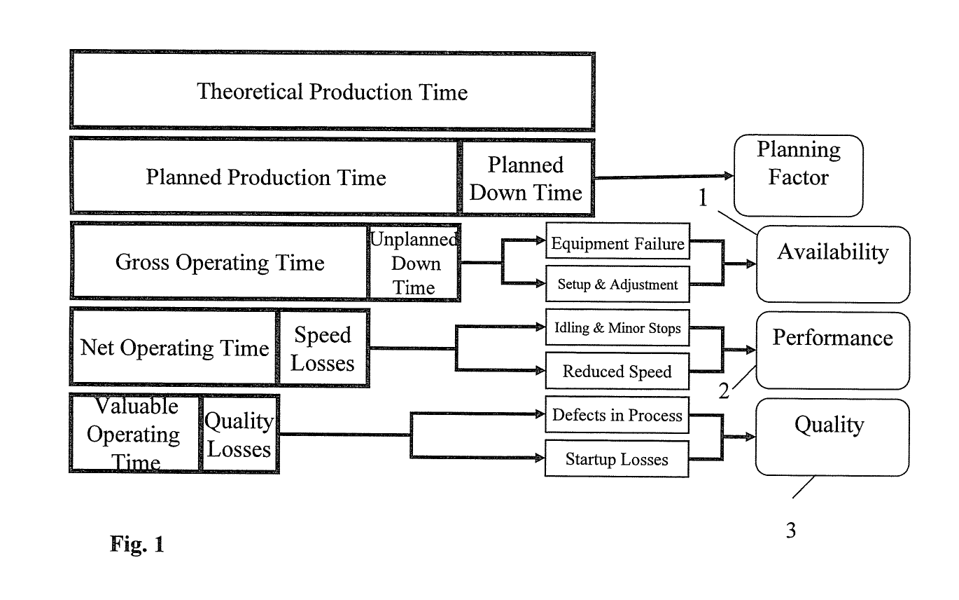

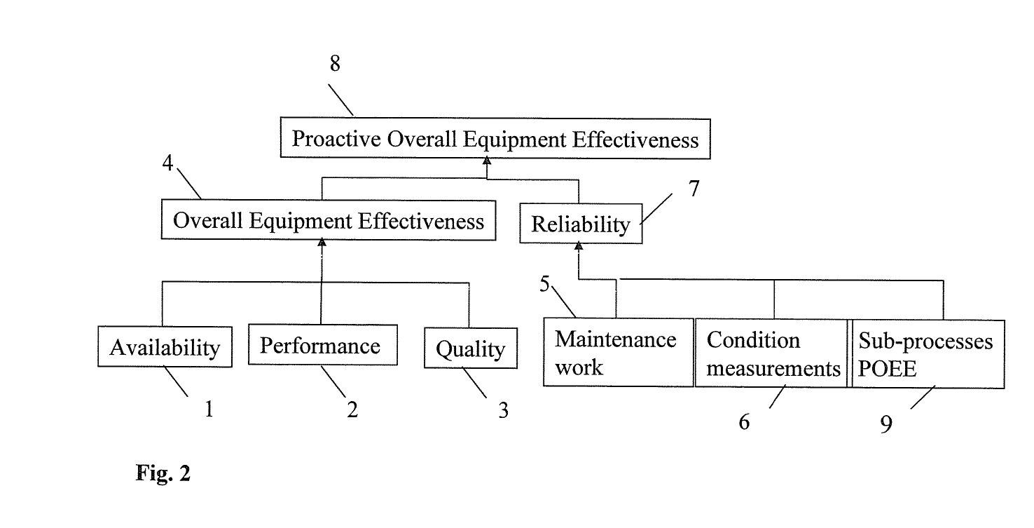

FIG. 1 illustrates a prior art method for calculating the Overall Equipment Effectiveness (OEE). Overall Equipment Effectiveness 4 (see FIG. 2) is obtained as a product of availability 1, performance 2 and quality 3, OEE=Availability (1)×Performance (2)×Quality (3).

Theoretical production time is the amount of time the plant is open and available for equipment operation. Planned production time is theoretical production time less planned down time. The planning factor indicates the percentage of the total theoretical production time planned for—or realized, without expressing anything about the way the installation has been used in terms of effectiveness.

Availability 1 is the ratio of gross operating time to planned production time, where gross operating time is planned production time less unplanned down time. Performance 2 is the ratio of net operating time to gross operating time, where net operating time is operating time less speed loss or the relation of the actual production speed compared to the nominal, budgeted, or target production speed. Speed loss implies that the machine is operating but not at its maximum speed.

Quality 3 is the ratio of valuable operating time to net operating time, where valuable operating time is net operating time less quality losses. Loss of quality occurs when the machine makes products that are not within the set acceptance limits.

FIG. 2 illustrates a method for calculating a Proactive Overall Equipment Effectiveness.

Overall Equipment Effectiveness 4 is obtained as a product of availability 1, performance 2 and quality 3, OEE=Availability (1)×Performance (2)×Quality (3), as illustrated in FIG. 1.

Equipment reliability 7 is the probability of trouble-free operation. If there is an actual risk for equipment failure or performance decrease the equipment reliability is low. It is based on measurements, observations on the equipment and plans and calculated as a product of maintenance work 5 and equipment condition measurements 6. Maintenance work 5 can be calculated by comparing the current state of the preventive maintenance works to scheduled plan of maintenance works, or the actual operating hours since last maintenance to the planned amount of operating hours between maintenance, for instance. Equipment condition measurements 6 can be calculated by comparing equipment condition measurements, such as temperatures, pressures, vibrations, or other measurements to their targets and set exception limits, for instance. All the result factors in the calculations are normalized to percentage numbers describing the relative risk or condition of the equipment.

The equipment condition measuring 6 data and the maintenance work 5 data is continuously acquired in real-time and stored to equipment reliability calculation system. Equipment reliability 7 is calculated based on the equipment condition measuring 6 data and the maintenance work 5 data.

Proactive Overall Equipment Effectiveness 8 is a product of Overall Equipment Effectiveness 4 and Equipment Reliability 7, POEE=OEE×equipment Reliability.

The sub-processes which have an impact on the current calculation are taken to the calculation as a coefficient by means of the Proactive Overall Equipment Effectiveness of the sub-process 9.

POEE is a percentage number containing exception information that tells whether one or more of the reliability components have violated the set exception limits. The exception information may contain several priority levels.

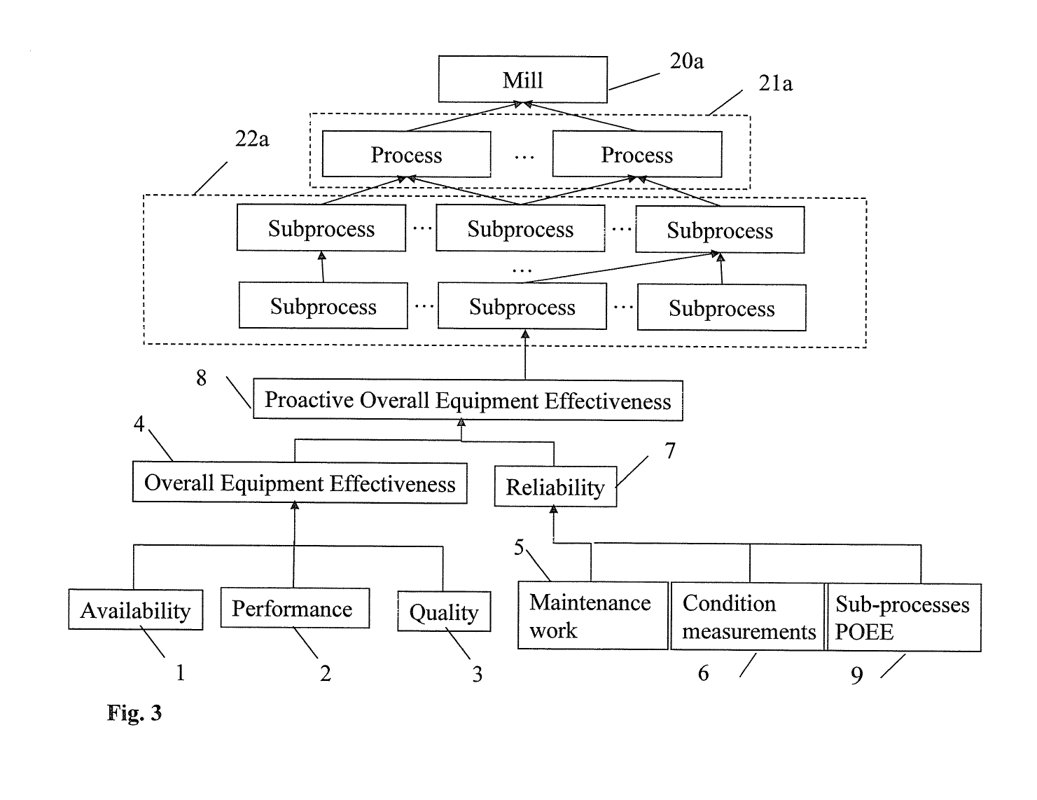

FIG. 3 illustrates a logical model of a mill for calculating and cumulating the proactive overall equipment effectiveness for an industrial plant. A logical model is made by dividing a mill 20a or production line into processes 21a and further to sub-processes 22a and defining their connections and impacts to each others. A sub-process can contain one or more equipments or other sub-processes. Examples of mills are paper or pulp mills.

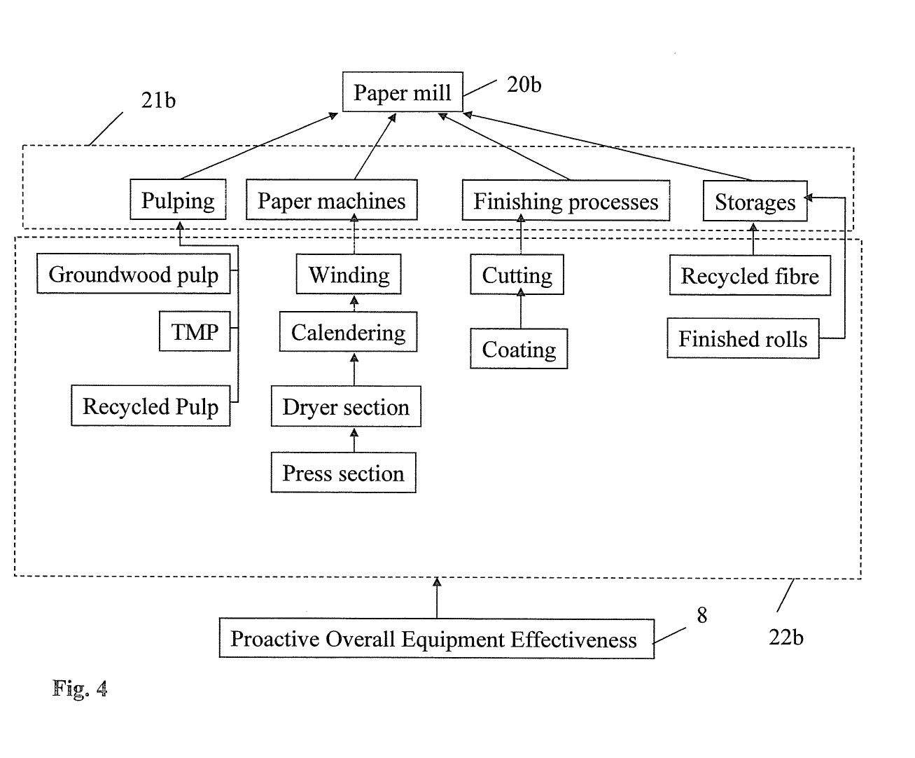

FIG. 4 illustrates a logical model of a mill for calculating proactive overall equipment effectiveness for an industrial plant. The example production plant is a pulp and paper mill 20b comprising a number of processes 21b and sub-processes 22b. Only some examples of processes and sub-processes in a paper mill are illustrated. For instance pulping, paper machines, finishing processes and storages are processes 21b in a paper mill.

Pulping 21b has sub-processes 22b as groundwood pulp, thermomechanical pulping (TMP) and recycled pulp. In groundwood pulp production, the logs of wood are pressed on grinding stones by means of mechanical presses. The wood is split into fibers with the help of water. The TMP process converts wood chips into fibers by heat and mechanical forces. Recycled pulp uses the wood fibres in recovered newspapers and magazines to produce a clean, bright pulp for manufacturing newsprint.

Paper machines 21b have sub-processes per one paper machine as winding, calendaring, dryer section and press section.

Finishing processes 21b have sub-processes 22b like cutting and coating.

Paper mill storage processes 21b have several storage sub-processes 22b like storages for recycled fibre and finished rolls.

The Proactive Overall Equipment Effectiveness is calculated for equipment, a sub-process, process and for a plant. If a sub-process contains several equipments, the values of the Proactive Overall Equipment Effectiveness are normalized, prioritized, and cumulated to the sub-process and further to connected sub-processes. The cumulation ends up to the Proactive Overall Equipment Effectiveness of the whole plant or production line. Each calculation of the Proactive Overall Equipment Effectiveness contains definitions for filtering the exception information in cumulation.

The Proactive Overall Equipment Effectiveness is calculated in an information system provided for the purpose. The system is a database, for instance, which receives information and data from the existing information systems in the paper mill, and is able to perform the calculation.

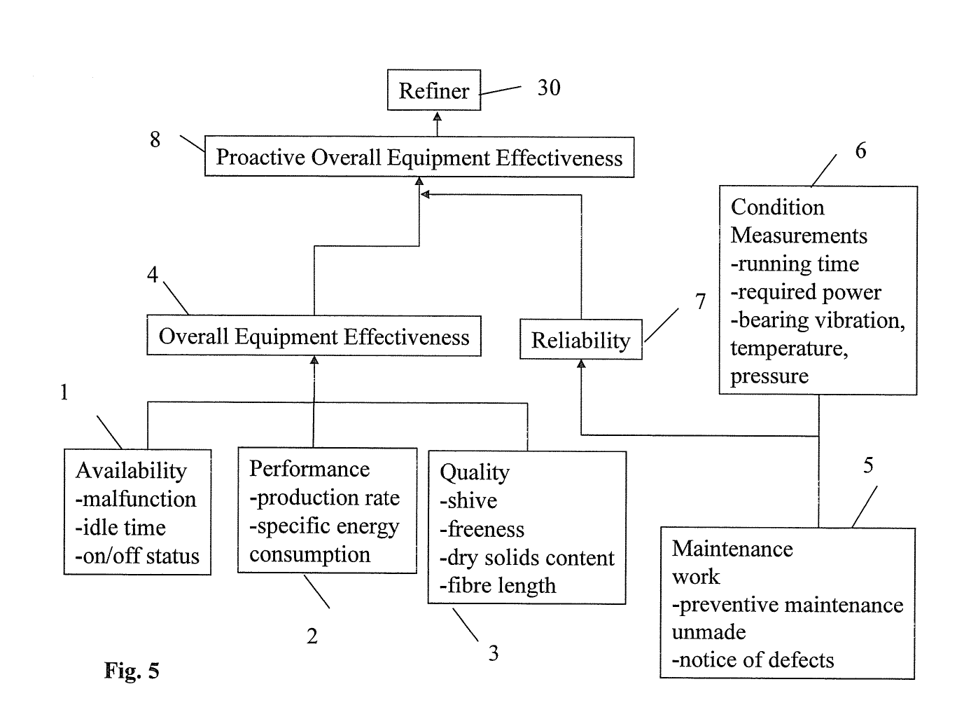

FIG. 5 illustrates calculation of proactive overall equipment effectiveness for a sub-process in a plant. The example plant is a paper mill shown in FIG. 4 and an example of a sub-process is TMP pulp. In TMP pulp sub-process there is further a sub-process refining. The equipment refiner 30 is a mechanical device used to produce mechanical pulp between grooved metallic discs, of which the other or both are rotating. The refiner 30 unit has at least two parts, the mechanical refiner and an electric motor for driving the refiner.

The calculation information for availability 1 comprises malfunctions, unplanned idle time and operational data like on/off status.

The calculation information for Performance 2 comprises production rate (ton/h) and specific energy consumption (MWh/ton).

The calculation information for Quality 3 comprises shive, freeness, dry solids content, and fibre length data.

The calculation information for maintenance work 5 comprises information on performed or unmade preventive maintenance and notice of defects. It contains also information from users. Information from the users can be user observations like a water leakage meaning that one or more sealings are breaking in the refiner, or a noise telling there is a trouble with the bearings of the motor.

The calculation information for equipment condition measurements 6 comprises data like refiner and motor total running time, refiner running time with new disks, the operating hours of the equipment since last maintenance have exceed the set limit, required power, bearing vibration levels, temperature of the bearings and oil pressure. The information is real-time measuring data from automation or condition monitoring systems of the pulp mill.

The existing information collected from different information systems is converted to support the operability of the production plant. Availability 1 information is from Distributed control systems (DCS). Performance 2 information comes from Distributed control systems (DCS) and Manufacturing Execution System (MES). Quality information 3 is from Manufacturing Execution System (MES). Maintenance work 5 obtains information from Computerized Maintenance Management System (CMMS). Equipment condition measuring 6 information comes from Distributed control systems (DCS) or condition monitoring system.

Proactive Overall Equipment Effectiveness 8 can be calculated in real-time by acquiring and combining the source information for each calculation parts from the Distributed control systems (DCS), condition monitoring, Manufacturing Execution System (MES), Computerized Maintenance Management System (CMMS) and/or other existing information systems in the industrial plant.

Proactive Overall Equipment Effectiveness 8 for the refiner is a product of Overall Equipment Effectiveness 4 and Equipment Reliability 7. If the OEE is 0.90 and Equipment Reliability is 0.95 then POEE=0.90×0.95=0.855. At least part of the production process is controlled by Proactive Overall Equipment Effectiveness. The value of Proactive Overall Equipment Effectiveness is compared to a limit value or to a set of limit values. Depending on the value of the Proactive Overall Equipment Effectiveness there can be different measures to be taken. With the Proactive Overall Equipment Effectiveness system the operations personnel can drill down to the factors causing the decrease in POEE and take the required measures to return it back to acceptable level.

For instance, if the value of the Proactive Overall Equipment Effectiveness is over the set limit values and the process is efficient no further actions is needed. If the value has decreased the reason for that is looked for, e.g. from all values of the calculation parts the ones being below a specific limit are selected for further inspection. If the value of Proactive Overall Equipment Effectiveness has decreased remarkably the decision is made whether to reduce the production rate or reduce the quality of produced goods (run lower quality/production rate/speed etc.), by the operations personnel or if it is necessary to stop the whole process or part of it.

Further, the operations of the personnel can also be partly controlled by Proactive Overall Equipment Effectiveness. The tasks to be performed by the personnel and their order can be listed based on their impact on Proactive Overall Equipment Effectiveness.

There may be several similar types of electric motors as in the refiner in the paper and pulp mill, and their maintenance work order can be defined based on the motor's impact on the Proactive Overall Equipment Effectiveness. Some of the motors may also be serviced with shorter intervals than other motors of the same type. That is equipment priorization.

In the refiner example above the calculation information are examples for each calculation part, e.g. for maintenance work 5. The calculation information depends on the application and can contain less information or more information of same or other type.

In the refiner example above the information sources are examples for each calculation part, e.g. for maintenance work 5. In reality several existing information sources for each calculation part can be used.

The invention has been described above with the help of certain embodiments. However, the description should not be considered as limiting the scope of patent protection; the embodiments of the invention may vary within the scope of the following claims.

1. A method for improving the operability of a production plant, where the production plant has at least one production process comprising at least one equipment, a system for obtaining equipment condition measuring data and a system for obtaining maintenance work data, wherein the equipment condition measuring data and the maintenance work data is continuously acquired and stored to equipment reliability calculation system, and equipment reliability is calculated based on the equipment condition measuring data and the maintenance work data.

2. A method according to claim 1, wherein Proactive Overall Equipment Effectiveness is calculated as a product of the equipment reliability and Overall Equipment Effectiveness.

3. A method according to claim 2, wherein Proactive Overall Equipment Effectiveness is calculated in real-time by acquiring and combining the source information from the Distributed control systems, condition monitoring, Manufacturing Execution System, Computerized Maintenance Management System and/or other existing information systems in the industrial plant.

4. A method according to claim 2, wherein at least part of the production process or the operations of the personnel is controlled by Proactive Overall Equipment Effectiveness.

5. A method according to claim 1, wherein the equipment condition measuring data and the maintenance work data is obtained real-time from at least one of the following in the production plant existing systems: Distributed control systems, Condition monitoring system, Manufacturing Execution System and Computerized Maintenance Management System.

6. A method according to claim 1, wherein the production plant is a pulp or paper mill.

7. A system for improving the operability of a production plant, where the production plant has at least one production process comprising at least one equipment, a system for obtaining equipment condition measuring data and a system for obtaining maintenance work data, wherein the system has means for continuously acquiring the equipment condition measuring data and the maintenance work data, and means for storing the acquired equipment condition measuring data and the maintenance work data to equipment reliability calculation system, and means for calculating equipment reliability based on the equipment condition measuring and the maintenance work data.

8. A software product data recording medium in which program code is stored, which program code will cause a computer to perform a method for improving the operability of a production plant, where the production plant has at least one production process comprising at least one equipment, a system for obtaining equipment condition measuring data and a system for obtaining maintenance work data, wherein the equipment condition measuring data and the maintenance work data is continuously acquired and stored to equipment reliability calculation system, and equipment reliability is calculated based on the equipment condition measuring data and the maintenance work data.
